(19) United States
(12) Patent Application Publication
(10) Pub. No.: US 2002/0180204 A1
(43) Pub. Date: Dec. 5, 2002

(54) Inserting page device

(76) Inventor: Jenny Lee Trump, Littleton, CO (US)

Correspondence Address: Jenny L. Trump, 7102 S. Robb St., Littleton, CO, 80127, US

(21) Appl. No.: 09/870,904

(22) Filed: May 31, 2001

(51) Int. Cl. B42D 3/00; B42F 13/00

(52) U.S. Cl. 281/29

(57) ABSTRACT

A thin, flat device (10) for enclosing photo pages (16), artwork, die cuts, papers (22) for quick application of page protecting products (20), photo sleeves, pockets, view binders etc. The device is made of a flexible material, with a spine (12) so it can be repeatedly bent, without fracturing, tearing or cracking. In addition it provides a fast, easy and hassles free approach to applying page protector products (20). Not only does it provide a quick method it also protects photo pages (16), artwork, die cuts and papers (22) during the application of page protector products (20).

### CROSS-REFERENCE TO RELATED APPLICATIONS

Not Applicable.

### STATEMENT REGARDING FEDERALLY SPONSORED RESEARCH OR DEVELOPMENT

Not Applicable

### REFERENCE TO A MICROFISCH APPENDIX

Not Applicable

### BACKGROUND OF THE INVENTION

This invention relates to inserting devices, specifically to slipping pages, papers; artwork, photos inside of page protector products, photo sleeves, pockets, albums and view binders. This invention pertains to the arts & crafts field of scrapbooking.

In the United States scrapbooking is considered the fastest growing hobby in America according to HIA (Hobby Industry Assoc.). Many hobbyist and non-hobbyist purchase page protector products for binders and albums. Americans purchase page protector products for hobbies and for business purposes. Despite this tremendous usage of page protector products, there continues to be a problem of inserting, pages, artwork, photos, and paper into these products. The completed work that is inserted into these page protector products is often bent, torn, separated or gets stuck upon application. Applying page protector products without an inserting page device is tedious and time consuming.

### BRIEF SUMMARY OF THE INVENTION

The present invention comprises of a inserting page device, which will aide, protect and make easier the application of page protector products, pockets, sleeves, and view binders. It is a primary objective of this invention to provide a device, which overcomes the disadvantages as briefly, outlined above.

Accordingly, besides the objects and advantages of the inserting page device described in my above patent, several objects and advantages of the present invention are:

(a) to provide an inserting device for an easier way of applying page protector products over art work, photo pages, and paper;

(b) to provide an inserting device which will prevent the sticking, bending of photos and artwork into page protector products, which currently occurs;

(c) to provide an inserting device with a quick and time saving approach to the application of page protector products;

(d) to provide an inserting device which protects pages, art work and photos, during application of page protector products;

(e) to provide an acid, PVC, and lignin free inserting page device for hobbyist to use when scrapbooking with photo albums;

(f) to provide an inserting device for a jam free way of slipping pages, photos etc. into view binders;

(g) to provide an inserting device that ends the hassles of applying page protector products;

(h) to provide an inserting device which is light weight and easy for travel and packing;

(i) to provide an inserting device which speeds up the current time of applying page protector products;

(j) to provide an inserting device which is durable, that will not tear or crack;

(k) to provide an inserting device which is colorful and easy to see amongst other tools;

(l) to provide an inserting device which satisfies a need in completing pages of an album or binder;

### BRIEF DESCRIPTION OF THE SEVERAL VIEWS OF THE DRAWING

FIG. 1 is a perspective view of an open, lying flat “inserting page device”.

FIG. 2 is a perspective view of a semi closed “inserting page device”.

FIG. 3 is a perspective view of a “inserting page device” wrapping around and covering a completed page of photo artwork in a binder or album

FIG. 4 is a perspective view of a “page protector product” sliding on top of the “inserting sleeve device”, which is covering the photo artwork

FIG. 5 is a perspective view of the “inserting page device” sliding out of the “page protector product; thereby leaving the “page protector product” directly on top making the completed page of artwork visible.

FIG. 6 is a perspective view of an elongated semi closed “inserting page device”.

FIG. 7 is a perspective view of an elongated “inserting page device” wrapping around and covering A completed page of artwork, not in a binder.

FIG. 8 is a perspective view of an “inserting page device” with artwork completely enclosed, sliding down into a top loading page protector product, which is in a binder.

FIG. 9 is a perspective view of the “inserting page device” sliding out of the page protector product, and leaving the artwork enclosed in the page protector product, which is in a binder.

### REFERENCE NUMERALS IN DRAWINGS

10 inserting page device

12 spine, binding, and groove

14 inside of inserting device

16 page of artwork etc. in a binder or album

18 rings/hinges on a binder/album

20 page protector product

22 artwork, photos, papers, die cuts

24 page of artwork loose, not in a binder

### DETAILED DESCRIPTION OF THE INVENTION

The preferred embodiment of the inserting page device 10 of the present invention is best illustrated in FIG. 1. The inserting page device 10 is made of a flat thin material, which can be repeatedly bent, folded without fracturing. In the preferred embodiment, the inserting page device 10 is a flexible plastic, such as high-density polyethylene available from Symplastics of St. Peters, Mo. In the preferred embodiment the inserting page device 10 is acid, lignin and PVC free.

As seen in FIG. 2, the inserting page device is folded 10. The inserting page device however, can consist of any other material that can be repeatedly folded, without fracturing. Such material as polyethleen, polypropylene, vinyl, nylon, rubber, leather, various impregnated or laminated fibrous materials, various plasticized materials, cardboard, paper etc. The inserting page device 10 is typically a 0.015 inches thick but can be a higher or lower thickness. The inserting page device 10 is typically in a rectangular shape 10. The outer four corners is typically squared to cover the greatest area, but they can be beveled or rounded for appearance. A vertical groove on the spine 12, is considered to be the binding in the center of the inserting page device 10. Groove 12 may be formed by machining, scoring, rolling or extruding.

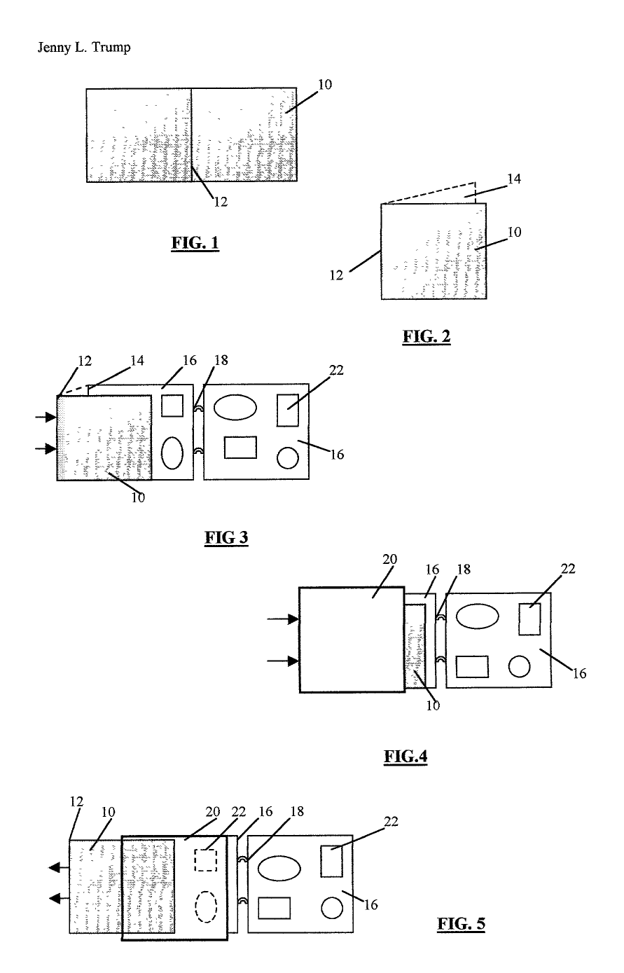

The inserting page device 10 as illustrated in FIG. 3 is enclosing 14 a page of artwork 16, photos, papers, die cuts and pages 22 inside of a hinged 18 or unhinged or ring binder or album.

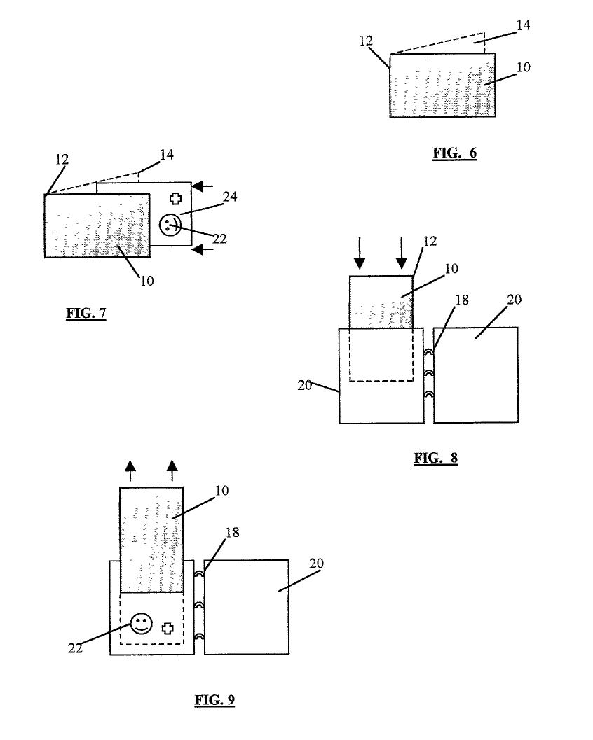

The inserting page device 10 in FIG. 4 which has a page of artwork 16 underneath it is being covered by a page protector 20, which is being slid on top of the inserting page device 10. In FIG. 5 the inserting page device 10 is being removed by sliding out of the page protector product 20 thus leaving behind the page of artwork 16, photos, paper, and die cuts 22. The photos, paper, die cuts 22 are now visible and protected under the page protector product 20 in an album.

The following figures are similar to FIGS. 1-5 except the inserting page device 10 is elongated to show a different method of use while applying page protector products 20. As seen in FIG. 6, it is the same as FIG. 2 except it is elongated, to show a different method of use. The inserting page device 10 as illustrated in FIG. 7 is enclosing around and covering a completed page of artwork 16, photos, papers, die cuts 22 although not in a binder.

The inserting page device 10 in FIG. 8 has artwork 22 completely enclosed, and is sliding down into a top loading page protector product 20 which is in a binder. In FIG. 9 the inserting page device 10 is being removed by sliding out of the page protector product 20 thus leaving behind the artwork, photos, paper, and die cuts 22. The photos, paper, die cuts 22 are now visible and protected under the page protector product 20 in a binder 18.

Advantages

From the description above, a number of advantages of the inserting page device become evident:

(a) a time saving advantage of using the inserting page device can be seen.

(b) the inserting page device ends the hassles and jams of slipping page protector products, photo sleeves, pockets onto artwork, photos, papers, die cuts etc.

(c) the use of the inserting page device wraps and protects the page or paper, which prevents sticking, bending or tearing artwork, photo pages, papers, die cuts and paper.

(d) with the use of colored plastic, the inserting page device is highly visible on an art table.

(e) the inserting page device ends former ways of applying page protector products, thus satisfying a need.

(f) the inserting page device is durable and flexible, will not crack, tear or fracture.

(g) for packing, the device is made of a lightweight flat material.

(h) The user will find enjoyment, once the method of application is seen.

(I) The inserting page device is safe for artwork due to the acid, lignin and PVC free material.

Operation—FIG. 3, FIG. 4, FIG. 5, FIG. 7, FIG. 8, FIG. 9

The manner of using the inserting page device 10 is shown by first enclosing the completed artwork 16, photos, papers, die cuts and pages inside 14 the inserting page device 10 (FIG. 3). The spine 12 of the inserting page device 10 is on the opposite side of the rings 18 or hinges 18 as found on photo albums, or binders 16 (FIG. 3).

As shown in FIG. 4 the inserting page device 10 has photos, papers, die cuts and artwork 16 completely covered and enclosed. The page protector product 20 now will slide on top of the inserting page device 10, which has the photo page artwork 16 enclosed. Suitable examples of page protector products 20, can be Creative Memories® portrait sleeve pages, page protector products, pocket pages etc; West Trims page protector products; Hobby Lobby® page sleeves; Avery® sheet protector products, side insert protectors, top insert protectors, quick load protector, view binders; Acco® custom cover presentation books, binders; and the like in various sizes and styles.

In FIG. 5 the inserting page device 10 being pulled out of the page protector product 20 by its spine thus making the completed artwork 22 visible through the page protector product 20.

In FIG. 7 shows the inserting page device 10 is enclosing a page of artwork 22. In FIG. 8, shows the inserting page device 10 with artwork 22 enclosed slides down into a top loading page protecting product, which is located in a binder. Once the inserting page device 10 has been inserted into the page protector product 20, it can be removed by holding the spine 12 and pulling it out. As seen in FIG. 9 the inserting page device 10 is being removed from the page protector product 20, thus leaving the artwork 22 visible through the page protector product 20.

Conclusion

Accordingly, the reader will see this invention can be used to apply page protector products easily and conveniently over artwork, etc. In addition this invention saves time by making the application of page protector products, less encumbersome. Further more the device has additional advantages in that It provides the hobbyist a hassle free approach of applying page protector products;

It provides a saving of time over the current method;

It provides durability, that will not crack, tear or fracture;

Its permits the hobbyist to locate it quickly amongst other tools, due to its color;

It provides an easier method, which satisfies a need;

It also provides protection of artwork etc. from getting stuck, bent, torn during the application of page protector products.

It provides the artist with an acid, lignin and PVC free device.

Although the description above contains much specificity, these should not be construed as limiting the scope of the invention but merely providing illustrations of some of the presently preferred embodiments of this invention. For example the inserting page device can have different, colors, materials, sizes, and spines. The binding can be replaced with a hinge that connects two otherwise unconnected halves, instead of one full piece together etc. The methods of use can vary from use with top load, side load and bottom load page protector products. Thus the appended claims and their legal equivalents should determine the scope of the invention, rater then by the example given.

What I claim as my invention is:

1. An inserting page device used for inserting artwork, photos, papers etc. into page protector products.
(A.) comprising of a flat body of material.
(B.) said material having a predetermined elongated shape of sufficient size to accommodate use for artwork, papers, photos and pages.

2. The device of claim 1 wherein said body of material is made of plastic.

3. The device of claim 1 wherein said sheet of material has a vertical groove in the center, which can be folded.

4. The device of claim 1 wherein said elongated shape is rectangular.

5. A method of inserting pages, artwork, photos, papers, etc. into page protecting products comprising steps of:
(A.) providing a flat device, which encloses pages, artwork photos, papers etc.
(B.) inserting the said device with said enclosures into a page protecting product.
(C.) griping the spine of the said device, and pulling it out of the page protecting product. Whereby said pages, artwork, photos, papers are visible inside the page protecting product.
